(19) United States
(12) Patent Application Publication
(10) Pub. No.: US 2021/0003047 A1
(43) Pub. Date: Jan. 7, 2021

(54) Electromagnetic Control Device, In Particular for Adjusting Camshafts of an Internal Combustion Engine

(71) Applicant: Kendrion (Villingen) GmbH, Villingen-Schwenningen OT (DE)

(72) Inventors: Tsuneo Suzuki, Monchweiler (DE); Michael Tischtschenko, Trossingen (DE); Andreas Kammerer, Obereschach (DE); Pedro Marull-Kessler, Monchweiler (DE)

(73) Assignee: Kendrion (Villingen) GmbH, Villingen-Schwenningen, OT (DE)

(21) Appl. No.: 16/330,711

(22) PCT Filed: Aug. 25, 2017
(86) PCT No.: PCT/EP2017/071412

§ 371 Date: Mar. 5, 2019

(30) Foreign Application Priority Data
Sep. 7, 2016 (DE) 10 2016 116 776.2

(51) Int. Cl. F01L 13/00; H01F 7/16; H01F 7/08; F01L 1/047

(52) U.S. Cl. CPC F01L 13/0036; H01F 7/1607; H01F 7/081; F01L 1/047; F01L 2820/031; F01L 2013/0052; H01F 2007/086

(57) ABSTRACT

The application relates to an electromagnetic control device, in particular for adjusting camshafts or a camshaft section of an internal combustion engine, comprising: an energizable coil unit via which, in the energized state, an armature mounted for movement along a longitudinal axis of the control device can be moved relative to a pole core between a retracted position and an extended position; a tappet which interacts with the armature and is mounted for movement along the longitudinal axis, having a free end, via which the tappet interacts with the camshaft in the extended position in order to adjust the camshaft; and an adapter, via which the control device can be fastened to a component, in particular to cylinder head cover, wherein the armature and the tappet are connected to each other for conjoint rotation, and the control device has a first bearing section inside the adapter for rotatable mounting of the tappet and a second bearing section outside of the adapter for rotatable mounting of the tappet and/or the armature.

The present patent application relates to an electromagnetic control device, in particular for adjusting camshafts of an internal combustion engine.

Camshafts have a number of cams, which form eccentric sections on the camshaft. The cams may be arranged fixedly on the camshaft or on camshaft sections, which may be applied to a cylindrical shaft for conjoint rotation but axial displacement. Axially displaceable components situated adjacent to the cams can be displaced at regular intervals by rotation of the camshaft. One application of the camshafts to be emphasized involves opening and closing of valves in an internal combustion engine. In a modern internal combustion engine, the engine characteristics can be adjusted from more comfortable characteristics to sporty characteristics, this being determined by, among other things, a change in the valve lift, which is determined by the shape of the cams. Furthermore, different engine rotational speeds require variable valve lifts to optimize the torque and the fuel consumption. Other internal combustion engines have a cylinder shutdown, in which some of the cylinders can be shut down to save on fuel. In this case, the valves of the shutdown cylinders must not be opened again. Again in this case, it is advantageous not only to shut down individual cylinders but also to enable variable valve lifts for the reasons given above.

Such internal combustion engines require camshafts that have cams of different sizes and shapes. However, in order to be able to open and close the valve with different valve lift curves, the camshaft or the camshaft section must be displaced axially to allow the respective cams to interact with the valve. With known control devices, such as those described in EP 2 158 596 B1, DE 20 2006 011 904 U1 and WO 2008/014996 A1, the camshafts have different grooves, in which an actuator engages with a different number of tappets. The tappets can be moved between a retracted position and an extended position, such that the tappets engage in the grooves in the extended position. The grooves constitute a guide section and, together with the engaging tappets, they form a sliding block guide for axial adjustment of the camshaft, which must be rotated by a certain amount to do so.

In most standard design four-stroke internal combustion engines, the camshafts rotate at half the rotational speed of the crankshaft so that the camshafts may easily rotate at speeds of up to 3000 rpm or more. Because of these high rotational speeds, high radial forces act like an impact on the tappets. With the control devices described above for adjusting camshafts or a camshaft section, the tappets are mounted only in housing sections, which are also known as adapters and with which the control device can be attached to a component, in particular a cylinder head cover. The bending moments acting on the tappets due to the high radial forces can cause the tappets to bend to such an extent that they become jammed in the adapters. Consequently, they are no longer movable between the retracted position and the extended position, so that the camshaft or the camshaft section also can no longer be displaced axially.

To counteract this disadvantage, the tappet according to DE 10 2013 102 241 A1 is mounted not only in the adapter but also in the pole core, which is arranged at a definite distance from the adapter. In WO 2016/001 254 A1, the tappet is mounted not only in the adapter but also in the armature, which is likewise arranged at a definite distance from the adapter.

To minimize the wear on the free end of the tappet, with which the latter engages in the groove in the camshaft, the tappet is mounted to rotate in the control device. In contrast with that, however, the armature in DE 10 2013 102 241 A1 and WO 2016/001 254 A1 is connected to the tappet by means of a loose fit. Consequently, only the axial forces but no torques acting about the longitudinal axis can be transferred. The rotation of the tappet on engagement in the groove of the camshaft is therefore not transmitted to the armature. Because of the rotation of the tappet relative to the nonrotating armature, wear occurs at spots where the tappet and/or the armature begin to show wear during operation of the control device, where the armature and the tappet come in contact with one another. In this way, the axial position of the armature relative to the tappet can change in particular, so that the tappet can no longer engage in the groove to the required extent. Consequently this may result in malfunctions or even failures.

The object of one embodiment of the present invention is to create an electromagnetic control device in particular for adjusting camshafts or a camshaft section of an internal combustion engine with which the disadvantages outlined above can be eliminated or at least tangibly reduced. In particular, a control device is to be created, with which the high bending moments acting on the tappet during operation can be absorbed reliably, so that the tappet does not jam. At the same time, the wear between the armature and the tappet should be reduced, so that their relative positions and in particular their axial positions relative to one another do not change during operation.

This object is achieved with the features defined in claim 1. Advantageous embodiments are the subject matter of the dependent claims.

One embodiment of the invention relates to an electromagnetic control device for adjusting camshafts of an internal combustion engine in particular, comprising an energizable coil unit, with which an armature mounted to be movable along a longitudinal axis of the control device in the energized condition can be moved between a retracted position and an extended position relative to a pole core, a tappet interacts with the armature is mounted to be movable along the longitudinal axis and has a free end, with which the tappet interacts in the extended position for adjusting the camshaft therewith, and has an adapter, with which the control device can be attached to a component, in particular to a cylinder head cover, wherein the armature and the tappet are connected to one another for conjoint rotation, and the control device has a first bearing section inside the adapter for rotatable mounting of the tappet and has a second bearing section outside of the adapter for rotatable mounting of the tappet and/or of the armature.

Due to the fact that the armature and the tappet are connected to one another for conjoint rotation, the rotation of the tappet on engaging in the groove of the camshaft or the camshaft section is transferred to the armature. Consequently, there is no relative rotational movement between the armature and the tappet so therefore there are no wear spots there anymore that could result in a change in the axial positions of the tappet and the armature relative to one another. A limited relative axial mobility between the armature and the tappet may be provided because it results in a definite reduction in wear in comparison with that of the rotational movement or none at all. From a manufacturing standpoint, it is advisable to manufacture the armature with the tappet by compression molding, so that the armature and the tappet are capable of both translational and rotational movement in synchronization.

Jamming of the tappet due to bending moments acting on it during operation is prevented by the fact that the tappet is mounted not only in the first bearing section but also in the second bearing section. The first bearing section is arranged inside the adapter while the second bearing section is arranged outside of the adapter, and consequently, is at a distance from the first bearing section. It is therefore advisable to arrange the second bearing section downstream, as seen from the free end of the tappet. Even a small distance is sufficient here to prevent bending and the resulting jamming of the tappet. Either the tappet or the armature or both together may be mounted in the second bearing section. When the tappet is connected to the armature for conjoint rotation accordingly, mounting of the armature in the second bearing section causes an indirect mounting of the tappet in the second bearing section. This is true even more so if the armature is produced by compression molding with the tappet.

According to another embodiment, the second bearing section is made of a nonmagnetic or nonmagnetizable material. Because of energization of the coil unit, a magnetic field is generated, acting on the armature and moving it in relation to the pole core. If the second bearing section is made of a nonmagnetic, nonmagnetized or nonmagnetizable material, the magnetic field lines are not destroyed or diverted. The second bearing point therefore need not be taken into account further in the design of the coil unit, the armature and the pole core, so that it is possible to rely on designs that have already been tried and tested so that the increased structural complexity for implementing the proposed control device in this embodiment can be minimized.

In a further improved embodiment, the second bearing section may comprise a friction bearing or be formed by a friction bearing. Friction bearings are a very popular and accepted machine element so that the second bearing section may be design inexpensive and reliably. Standardized friction bearings in particular can be used, thereby further reducing costs. In addition friction bearings are largely maintenance free and capable of absorbing high force. Friction bearings are lubricated by the motor oil used in the internal combustion engine.

In a further refined embodiment, the friction bearing may be made of plastic or a nonmagnetic or nonmagnetizable stainless steel. Many friction bearings are also available in these materials, so this restriction on the choice of materials does not result in any mentionable increase in cost. Furthermore, this ensures that the magnetic field lines are not disturbed.

In another embodiment, the friction bearing may be arranged in a tubular body. The tubular body may be shrunk onto the friction bearing, for example, so that a secure connection can be created without any additional connecting elements so that manufacturing is simplified. Furthermore, the tubular body may be designed so that it must be inserted into the control device only with a few manipulations and at the same time the position of the friction bearing is secured so that assembly is also simplified. Alternatively, the tubular body may form the second bearing section without using a friction bearing, for example, through a corresponding design of the surface which comes in contact with the armature and/or with the tappet. In particular when the friction bearing is made of a nonmagnetic material, no magnetic forces are in effect between the armature and the friction bearing, which reduces the friction between the armature and the friction bearing. It is possible in this way to reduce wear, on the one hand, while on the other hand, the rate at which the armature and consequently the tappet are moved can be increased. In addition, the friction bearing may be of such dimensions that a gap is formed between the armature and the tubular body. This also prevents the magnetic forces acting between the armature and the tubular body from causing friction, with the aforementioned disadvantages.

A further improved embodiment is characterized in that the device includes a spring element having a first end and a second end, which is supported on the first end by means of a spring plate on the tappet or on the armature and is supported at the second end on the second bearing section. It is quite possible for the armature and therefore the tappet to be moved into the desired directions along the longitudinal axis only by means of a corresponding energization of the coil unit. However, this requires a more complex control electronic system accordingly. Furthermore, a certain amount of time elapses until the magnetic field that is present has dissipated and the new magnetic field has built up. With the help of the spring element, the tappet can already be moved in the corresponding direction if the magnetic force applied to the armature by the magnetic field and the magnetic force counteracting the prestressing force of the spring element far below a certain level. To this extent, the tappet can be moved more rapidly. The spring plate can be secured on the tappet or on the armature by means of a loose fit and secured axially by means of a shoulder in the active direction of the prestressing force. Therefore, the rotational movement of the tappet is not transferred to the spring element, so there is no twisting or wear on the spring element. On the second end, the spring element is supported on the second bearing section and in particular on the friction bearing, so it is not necessary to take more extensive structural measures to secure the axial position of the spring element. This minimizes the manufacturing complexity. Furthermore, the spring plate can be arranged movably inside the tubular body, so that the spring plate is guided by the tubular body. This prevents tilting or tipping or sticking of the spring plate on neighboring components.

According to a further embodiment, the adapter has a stop against which the spring plate is stopped in the extended position. As mentioned previously, the wear on the tappet on engagement in the groove should be reduced due to the fact that it is rotatably mounted. In this way, the tappet can roll on the side surfaces of the groove, thereby preventing or at least reducing any type of sliding that promotes wear. Wear on the tappet can be further reduced by the fact that the tappet engages in the groove in the extended condition but does not rest on the bottom surface of the groove or does so only when the depth of the groove is reduced at the outlet of the groove. Since the spring plate strikes against the stop of the adapter, which may be designed as a shoulder, for example, the extended position is clearly defined. Furthermore, with a corresponding arrangement of the tappet relative to the groove, this ensures that the tappet at its free end does not come in contact with the bottom surface of the groove outside of the outlet of the groove, thereby reducing wear on the free end of the tappet.

A further improved embodiment is characterized in that the device has a permanent magnet, with which the armature in the unenergized condition of the coil unit is held in the retracted position. To be sure, the armature is kept in the retracted position by a corresponding constant energization of the coil unit, to which end, however, a corresponding amount of electric power is required. This electric power can be saved by using a permanent magnet, so that the control device can be operated economically.

Examples of embodiments of the invention are described in greater detail below with reference to the accompanying drawings, in which:

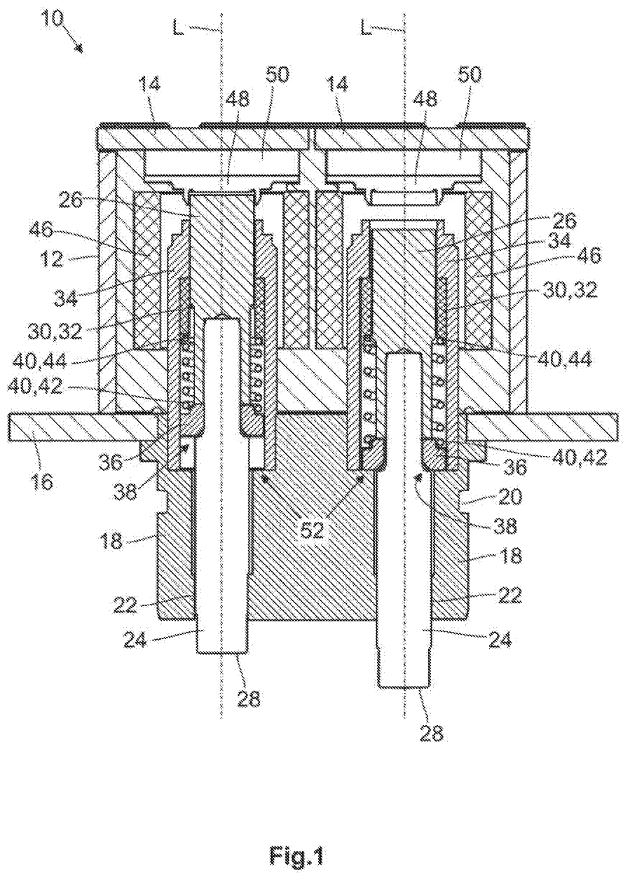

FIG. 1 shows a basic sectional diagram through one embodiment of a proposed electromagnetic control device.

FIG. 1 shows an embodiment of an inventive electromagnetic control device 10 on the basis of a basic sectional diagram. FIG. 1 shows that the control device 10 has two components of identical design. For reasons of clarity, essentially only one of the components is described below, but the description also applies to the other component.

The control device 10 has a housing 12 which is designed essentially in the form of a pipe in the embodiment illustrated here. With respect to the diagram shown in FIG. 1, the housing 12 is closed with a flange 16 at the lower end and with a cover 14 at the upper end. The control device 10 has an adapter 18 attached to the flange 16. With this adapter 18, the control device 10 can be attached to a cylinder head cover of an internal combustion engine, for example (not shown). The adapter 18 has recesses 20 into which gaskets (not shown) can be inserted to seal the control device 10 with respect to the cylinder head cover.

The adapter 18 forms a first bearing section 22 for a tappet 24 that is displaceable along a longitudinal axis L of the control device 10. The first bearing section 22 may be provided, for example, by the fact that the outer surface of the tappet 24 is provided with a corresponding surface quality just like the inner surface of the adapter 18, which comes in contact with the outer surface of the tappet 24. The first bearing section 22 is lubricated by the motor oil of the internal combustion engine. To be able to reliably absorb the high axial forces acting on the tappet 24 during operation, the adapter 18 is made of a hardened stainless steel.

The tappet 24 in the embodiment illustrated here is produced with an armature 26 by compression molding and is therefore connected to it for conjoint rotation. The conjoint rotation connection may also be implemented by some other method, for example, by welding. To achieve good compression molding, the armature 26 has a recess, in which the tappet 24 engages over a lengthy section. The tappet 24 has a free end 28 which protrudes beyond the adapter 18.

In the embodiment shown here, the control device 10 has a second bearing section 30, which is arranged behind the first bearing section 22, as seen from the free end 28 and is designed as a friction bearing 32. The friction bearing 32, which is manufactured from a plastic, for example, or a nonmagnetic stainless steel, is arranged in a tubular body 34 and is connected to the tubular body 34 by means of a shrink fit, for example. In the example shown here, the friction bearing 32 is arranged so that only the armature 26 is supported with the friction bearing 32. Consequently, the second bearing section 30 is situated inside the housing 12. Both the first bearing section 22 and the second bearing section 30 are designed so that the tappet 24 and the armature 26 are mounted to rotate about the longitudinal axis L as well as to be displaceable along the longitudinal axis L. The friction bearing 32 protrudes radially inward somewhat beyond the tubular body 34 so that a narrow gap is formed between the tubular body 34 and the armature 26. The tubular body 34 and the armature 26 are therefore not in contact with one another.

Furthermore, the control device 10 has a spring plate 36 which extends around the tappet 24 in the form of a ring and has a loose fit with respect to the tappet 24 and is contact with the tappet 24 in the area of an enlarged diameter 38 thereof. In addition the spring plate 36 is secured axially by means of the armature 26. Consequently, the spring plate 36 executes the same axial movements along the longitudinal axis L as the armature 26 and the tappet 24. As shown in FIG. 1, the spring plate 36 is enclosed radially by the tubular body 34. In the axial movements of the spring plate 36, the spring plate 36 is guided by the tubular body 34.

In addition a spring element 40 having a first end 42 and a second end 44 is provided. The spring element 40 may supply a prestressing force that acts essentially along the longitudinal axis L. The spring element 40 is supported with the first end 42 on the spring plate 36 and with its second end 44 on the friction bearing 32. Because of the loose fit of the spring plate 36 with respect to the tappet 34, rotational movements of the tappet 24 are then transferred to the spring plate 36 only when the prestressing force with which the spring plate 36 is pressed against the area of enlarged diameter 38 exceeds a certain level.

To move the armature 26, the control device 10 includes a coil unit 46 enclosing the armature 26 and forming an annular gap. In addition, a pole core 48 which is provided is arranged above the armature 26 based on the diagram shown in FIG. 1. Furthermore, the control device 10 has a permanent magnet 50 which is attached to the cover 14 and is arranged above the pole core 48.

Due to the fact that the armature 26 and the tappet 24 are produced together by compression molding, they always execute the same movements. Consequently, the tappet 24 and the armature 26 do not execute any movements relative to one another so that there are no wear spots caused by the relative movements between the armature 26 and the tappet 24. The left tappet 24 and the left armature 26 are in a retracted position, whereas the right tappet 24 and the right armature 26 are in an extended position.

The control device 10 is operated in the following manner: the permanent magnet 50 exerts an attractive force on the armature 26 acting along the longitudinal axis L, so that the armature 26 is pulled by the permanent magnet 50 in the retracted condition and is in contact with the pole core 48. The spring element 40 is compressed in this way, so that the spring element 40 supplies a prestressing force, which, however, is lower than the attractive force of the permanent magnet 50. Consequently, the armature 26 and the tappet 24 assume the retracted position.

If the coil unit 46 is now energized, a magnetic field is built up, inducing a magnetic force on the armature 26, causing an action in the same direction as the prestressing force supplied by the spring element 40, and consequently, against the attractive force of the permanent magnet 50. The sum of the magnetic force and the prestressing force is greater than the attractive force of the permanent magnet 50, so that the armature 26, and consequently, the tappet 24 are moved away from the permanent magnet 50 along the longitudinal axis L until the spring plate 36 strikes against a stop 52 on the adapter 18, so that the tappet 24 and the armature 26 have reached the same extended position. In this extended position, the tappet 24 engages at its free end 28 in a groove in a camshaft (not shown) or a camshaft section (also not shown). The groove has a helical shape, based on the axis of rotation of the camshaft, so that engagement of the tappet 24 in the groove causes a longitudinal adjustment along the axis of rotation of the camshaft about its own axis of rotation in combination with the rotation of the camshaft. To transfer the corresponding axial forces, the tappet 24 is in contact with one of the side walls of the groove on which it rolls, so that the tappet 24 is rotated at a very high rotational speed on engagement in the groove. Because of the compression molding of the armature 26 with the tappet 24, the rotational movement of the tappet 24 is also transferred to the armature 26. The stop 52 of the adapter 18 and the depth of the groove are selected so that the tappet 24 in the extended position does not at its free end 28 contact the bottom surface of the groove. However, the depth of the groove decreases toward the end, so that beyond a certain angle of rotation of the camshaft, the free end 28 of the tappet 24 comes in contact with the bottom surface of the groove, so that the tappet 24 is again displaced in the direction of the permanent magnet 50. Then at the latest, energization of the coil unit 46 is interrupted, so that the attractive force exerted by the permanent magnet 50 on the armature 26 is again greater than the sum of the prestressing force supplied by the spring element 40 and the magnetic force, which is no longer in effect due to the lack of energization of the coil unit 46. Consequently, the tappet 24 and the armature 26 again assume the retracted position until the coil unit 46 is again energized.

### LIST OF REFERENCE NUMERALS

10 Control device
12 Housing
14 Cover
16 Flange
18 Adapter
20 Recesses
22 First bearing section
24 Tappet
26 Armature
28 Free end
30 Second bearing section
32 Friction bearing
34 Tubular body
36 Spring plate
38 Area of enlarged diameter
40 Spring element
42 First end
44 Second end
46 Coil unit
48 Pole core
50 Permanent magnet
52 Stop
Longitudinal axis

1. An electromagnetic control device, comprising:
an armature;
an energizable coil unit, with which the armature is mounted to be movable along a longitudinal axis of the control device in an energized condition and is movable between a retracted position and an extended position relative to a pole core;
a tappet which interacts with the armature and is mounted for movement along the longitudinal axis and has a free end by which the tappet interacts with a camshaft in the extended position for adjusting the camshaft;
an adapter to a cylinder head cover;
a first bearing section within the adapter for rotational bearing of the tappet;
a second bearing section outside of the adapter for rotatable mounting of the tappet and/or the armature; and
wherein the armature and the tappet are connected to one another for conjoint rotation.

2. The control device according to claim 1, wherein the second bearing section is made of a nonmagnetic or nonmagnetizable material.

3. The control device according to claim 1, wherein the second bearing section comprises a friction bearing or is formed by the friction bearing.

4. The control device according to claim 3, wherein the friction bearing is made of plastic or a nonmagnetic or a nonmagnetizable stainless steel.

5. The control device according to claim 3, wherein the friction bearing is arranged in a tubular body.

6. The control device according to claim 1, further comprising:
a spring element having a first end and a second end, the spring element being supported on the first end by a spring plate on the tappet or on the armature and being supported at the second end on the second bearing section.

7. The control device according to claim 5, wherein the adapter has a stop against which the spring plate is stopped in the extended position.

8. The control device according to claim 1, further comprising:
a permanent magnet, with which the armature in an unenergized condition of the coil unit is held in the retracted position.

9. A device, comprising:
a housing having a longitudinal axis;
an energizable coil unit located in the housing;
a tappet that extends along the longitudinal axis and having a free end for interaction with a camshaft;
an armature fixed to the tappet and extending along the longitudinal axis;
an adapter extending from the housing and having a first bearing section for rotational bearing of the tappet, wherein the first bearing section is located in the adapter and outside of the housing;
a second bearing section located in the housing for rotational bearing of the tappet, the armature, or both the tappet and armature;
wherein the tappet is rotatably mounted in the first bearing section, and the armature, the tappet, or both the armature and tappet, are rotatably mounted in the second bearing section; and
wherein the tappet and armature conjointly rotate and move longitudinally along the longitudinal axis between a retracted position and an extended position without rotation of the tappet and armature relative to each other.

10. The device according to claim 9, further comprising:
a spring having a spring first end and a spring second end;
a spring plate;
wherein the spring first end is supported by the spring plate on the tappet or on the armature and the spring second end is supported on the second bearing section.

11. The device according to claim 10, wherein the adapter has a stop against which the spring plate is stopped when the tappet and armature are in the extended position.
